(19) United States
(12) Patent Application Publication
(10) Pub. No.: US 2006/0021723 A1
(43) Pub. Date: Feb. 2, 2006

(54) Roll-up window shade with varying transparency

(75) Inventors: Roland Schneider, Ulm (DE); Uwe-Gert Heiner, Tubingen (DE); Joachim Heebaart, Tubingen Hagelloch (DE); Hans Kohn, Reutlingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignees: BOS GmbH & Co. KG, Ostfildern (DE); rokona Textilwerk GmbH, Tubingen (DE)

(21) Appl. No.: 11/188,913

(22) Filed: Jul. 25, 2005

(30) Foreign Application Priority Data
Jul. 28, 2004 (DE) 10 2004 036 649.7

(51) Int. Cl. B60J 1/20

(52) U.S. Cl. 160/370.22

(57) ABSTRACT

A roll-up window shade assembly for motor vehicles is provided. The roll-up window shade assembly includes a roll-up window shade element having a transparency that is anisotropic over its surface area. As desired, the transparency can change from the top edge of the window to the bottom edge of the window in the sense that a better transparency is provided in the region of the bottom edge of the window. Alternatively, the transparency can change from the rear edge of the window to the front edge of the window with the best transparency being provided next to the front edge of the window.

### BACKGROUND OF THE INVENTION

In motor vehicles, roll-up window shades are used to shield the interior of the motor vehicle from excessive sunshine. In this way, glare and also excessive heating of the interior are avoided. The avoidance of excessive heating is particularly important in vehicles with air conditioning systems, because the cooling output produced by the air conditioning system can be reduced through the use of sunshades.

As a rule, wind-up shafts in roll-up window shades are housed underneath the window in the car body or in the door, for reasons of space. On the other hand, the sun is at a substantially steep angle when its rays need to be reduced by a roll-up window shade. Therefore, it is often necessary to pull out the roll-up shade completely so that the desired shading effect is realized. In such situations, it would make no sense to pull out a roll-up shade coming from the bottom merely three quarters of the way, because a lot of objectionable sunlight would still come through the remaining gap of a third of the window area at the top edge of the window.

The degree of transparency of the shade material of the roll-up window shade depends on the desired shading effect. As a result, with for example rear roll-up window shades, the visibility through the rear window is considerably reduced when the roll-up window shade is pulled out.

Another reason for using roll-up window shades is to prevent persons from looking into the interior of the motor vehicle. In such cases, the roll-up window shade is also often pulled out completely, although actually only a portion of the shade would need to be pulled out in many situations.

### BRIEF SUMMARY OF THE INVENTION

In view of the foregoing, a general object of the present invention is to provide a roll-up shade for motor vehicle windows which is better adapted to the specific requirements of vehicles as well as the specific requirements of the driving of vehicles.

With the new roll-up window shade of the present invention, a wind-up shaft is provided that can be mounted next to the window so that the shaft can rotate. A roll-up shade element that can be pulled out from the wind-up shaft in a known manner either by hand or by an electric drive is attached to the wind-up shaft by one edge. The wind-up shaft itself is provided with a drive that can wind the wind-up shaft the direction in which the roll-up shade element winds onto the wind-up shaft.

With the roll-up window shade of the present invention, the roll-up shade element when viewed over its surface area is not homogeneous in terms of transparency. Instead, the degree of transparency varies from one edge to another. For example, in the case of a rear roll-up window shade, the degree of transparency in the area near the top edge of the window is less than near the bottom edge of the window. Therefore, the desired shading against sunlight is achieved while minimizing the adverse effect on the view out of the window. In particular, such an arrangement provides the ability to have even stronger light screening in areas that are appropriate for shading than is possible in roll-up vehicle shades exhibiting homogeneous light screening.

The same relationships also apply to roll-up side window shades, in which stronger light screening in the top region of the window is desired as compared with the bottom region of the window. This arrangement enables a better view to the outside, while significantly minimizing the sunlight reaching the interior of the vehicle. According to the position of the sun, a relatively small amount of sunlight still shines directly into the interior of the vehicle through the very transparent region as a result of aberration.

If the roll-up shade element has varying transparency in the direction parallel to the longitudinal axis of the vehicle, i.e. from the front edge to the rear edge of the window, it is possible to provide the persons in the back of the vehicle a good view to the outside while the people are barely visible from the outside of the vehicle because they are positioned behind the darker region of the roll-up shade.

Depending on the configuration of the roll-up shade, the varying transparency can change from the free edge of the roll-up shade in the direction toward the wind-up shaft or from one longitudinal edge of the roll-up shade element in the direction toward the other longitudinal edge. Which configuration is used depends on the desired direction of the transparency gradient and the position of the wind-up shaft relative to the direction of the gradient.

In roll-up shades made of fiber/thread material, the variance in the degree of transparency of the roll-up shade element can be achieved by varying the thread/fiber density. Varying the fiber thread density can be accomplished by varying the warp and woof density in a desired way when a fabric is used or by changing the fineness of the stitches or also the thread thickness when stitched material, for example, knitted fabric, is used. For a roll-up shade element made from perforated film, the hole diameter can be varied. However, films can be used in which the degree of transparency is varied through printing on the film. For example, the base carrier of the film can be essentially as clear as glass, while printing on the film gradually reduces the transparency. Finally, any arbitrary pattern can be used for such printing, preferably with a fineness so that from a certain distance the printing can no longer be recognized as consisting of individual lines.

The varying of the degree of transparency can be achieved in a continuous or abrupt manner. The particular method used to vary the degree of transparency that is chosen by someone skilled in the art will depend on the initial technical requirements and on the extent to which the different methods integrate into the overall picture of the vehicle.

A series of modifications of the disclosed embodiments is possible, as can be inferred by someone skilled in the art by studying the depiction of the figures alone.

### BRIEF DESCRIPTION OF THE SEVERAL VIEWS OF THE DRAWING(S)

FIG. 1 is a partially cutaway perspective view of an illustrative rear portion of a motor vehicle showing, in this case, the rear right side door.

FIG. 2 is a schematic drawing showing an exemplary roll-up window shade arrangement according to the present invention.

FIG. 3 is a partially cutaway top view of a sunroof of a motor vehicle which is equipped with a roll-up shade according to the present invention.

### DETAILED DESCRIPTION OF THE INVENTION

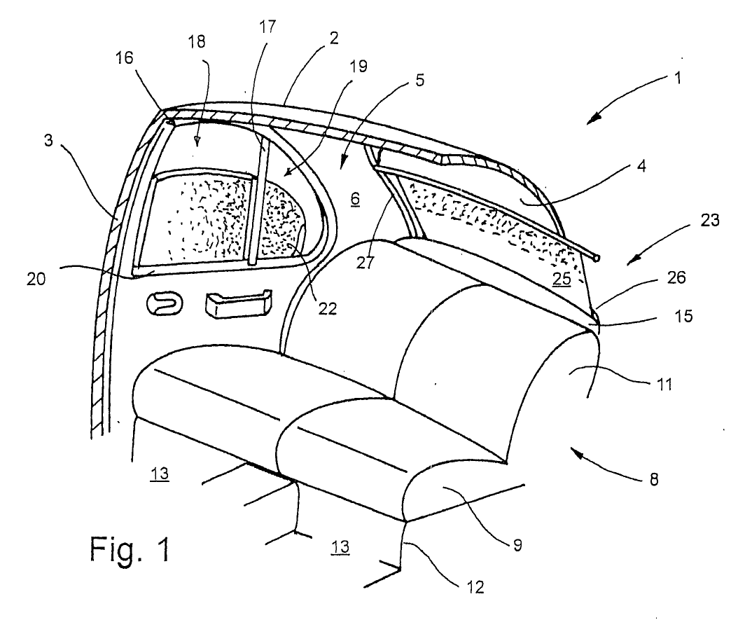

Turning now more specifically to the drawings, FIG. 1 shows in a partially cutaway view a rear section of a passenger motor vehicle. The right portion of the rear section of the motor vehicle is shown in FIG. 1. The left portion of the rear section is symmetrical to the right portion. FIG. 1 is somewhat simplified. Thus, for example, body internal structures, such as braces and attachment mechanisms, are not shown because their representation is not required for understanding the invention. The representation of the car body is also schematic in nature with the hollow spaces in the car body not being shown.

The illustrated car body section 1 has a roof 2 from which a B column 3 leads downward to a floor assembly. A corresponding B column is provided on the other side of the vehicle that is not shown in FIG. 1. The roof 2 transitions at its rear edge into a rear window 4. At the side, the rear window ends at a C column 5, which is located at a distance from the B column 3. The C column 5 carries an inner lining 6. Between the B column 3 and the C column 5, a right rear side door 7 is hinged to the B column 3 in a known way.

At the level of the right rear side door 7, a rear bench seat 8 is provided that includes a seat surface 9 as well as a rear seat back 11. The rear seat surface 9 lies on a base surface 12 which belongs to the floor assembly and in front of which is formed the foot space 13. A rear seat shelf 15 extends to the bottom edge of the rear window 4 at the level of the top edge of the rear seat back 11.

The right rear side door is provided with a side window 16 in a way that is typical of sedans. The side window 16 is divided by an approximately vertical brace 17 into an essentially rectangular window panel 18 and an approximately triangular window panel 19. At the bottom end, the two panels 18 and 19 are bordered by a continuous window sill 20. The window pane in the window panel 18 can move up and down in a known way, wherein it is guided in the vertical brace 17 in a known manner. The window pane in the triangular window panel 19 is fixed.

Window panels 18 and 19 are each shaded by associated roll-up shade elements 21 and 22. The drive mechanism for the two roll-up shade elements 21 and 22 is located in the interior of the door 7 underneath the window sill 20. On the inside of the motor vehicle, a rear window roll-up shade 23 is provided in front of the rear window 4. In FIG. 1, the partially pulled out roll-up shade element 25 of the rear window roll-up shade 23, which is pulled out through a slot 26 in the rear seat shelf 15, as well as one of the lateral guide rails 27 can be seen. The guide rail 27 begins at the rear seat shelf 15 behind the rear seat back 11 and extends to the window side edge. Another guide rail is arranged in a symmetrical relationship to the guide rail 27.

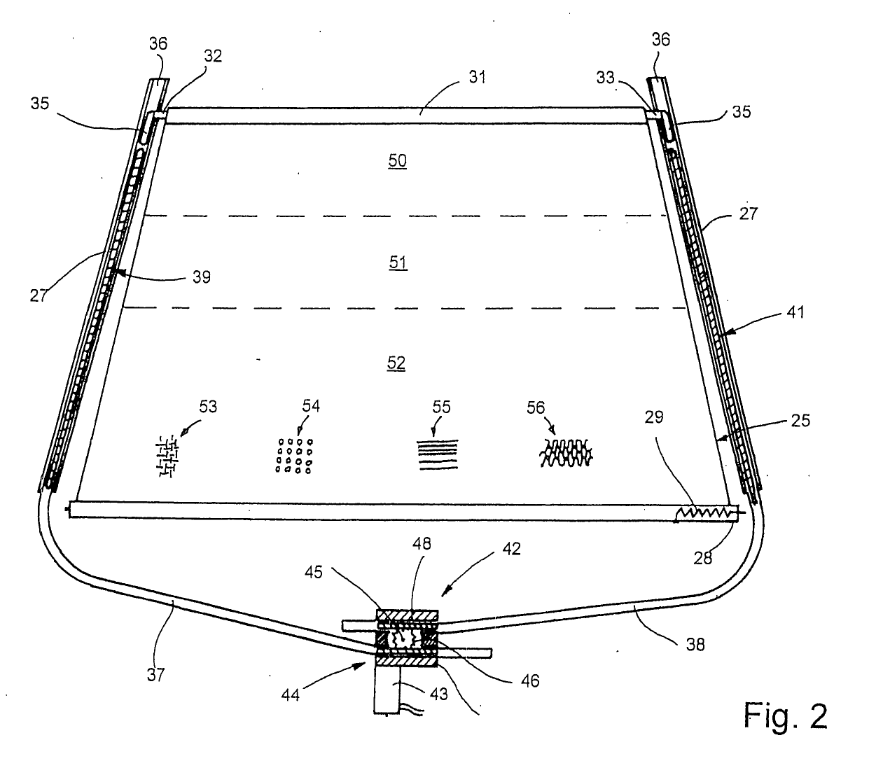

The basic design of the rear window roll-up shade 23 is best understood from FIG. 2. A wind-up shaft 28, to which the roll-up shade element 25 is fixed with one edge, is mounted underneath the rear seat shelf 15 so that the shaft can rotate. The wind-up shaft 28 is biased with the help of a schematically shown spring motor 29 in the direction associated with winding the roll-up shade element 25 onto the wind-up shaft 28. For this purpose, a helical spring is provided that on one end is anchored tightly to the car body and on the other end is fixed to the wind-up shaft 28.

The roll-up shade element 25 has an approximately trapezoidal outline and is provided on its edge remote from the wind-up shaft 28 with a tubular hanger 31. An extraction profile or bow within which end pieces 32 and 33 are mounted so that they can telescope is guided through the tubular hanger 31. The end pieces 32 and 33 have a throat section 34 with a smaller diameter than a guide element 35 that connects to this throat section and that is short and cylindrical. The guide elements 35 run in the guide rails 27 that are arranged next to the two side edges of the rear window 4.

Each of the guide rails 27 includes an undercut guide groove 36 that opens into a guide slot in the direction toward the roll-up shade element 25. The lower end of each guide rail 27 is connected to a guide tube 37, 38, in which two flexible push elements 39 and 41 are guided in a kink resistant way. The flexible push elements 39 and 41 are so called suflex shafts. They comprise a cylindrical core surrounded by a screw like rib. In this way, a type of flexible toothed rack with rounded teeth is obtained.

The guide tubes 37 and 38 connect the guide rails 27 to a geared motor 42. The geared motor 42 is assembled from a permanently excited DC motor 43 and a transmission 44, on whose output shaft 45 a spur pinion gear 46 is solidly seated. The gear 46 meshes with the two push elements 39, 41 with a positive fit. The push elements 39, 41 pass tangentially to the diametrically opposite sides of the spur pinion gear 46, and in this way are guided into corresponding bore holes 47, 48.

By actuating the geared motor 42, the push elements 39, 41 are selectively pushed forward or withdrawn. The end pieces 32, 33 follow the movement of the push elements 39, 41. These guide pieces are held in contact against the free ends of the push elements 39, 41, which are located in the guide grooves 36, with the help of the spring motor 29.

As shown in FIG. 2, the surface of the roll-up shade element 25 is divided into a total of 3 zones, 50, 51, and 52. The division of the zones is indicated by dashed lines. The zones 50, 51, and 52 extend from the left to the right edge of the roll-up shade element 25. They are arranged superimposed on one another in the longitudinal direction of the roll-up shade element 25, i.e., in the direction parallel to the direction of motion of the roll-up shade element 25.

As can be seen from FIG. 1, the degree of transparency in zone 50 should be the smallest. In FIG. 1, the region of the strongest light screening, thus zone 50, is indicated by dots. In zone 51, the degree of transparency is somewhat greater, while in zone 52 the transparency is practically not reduced at all, or only very slightly. In use, this means that when the sun is at a steep position and the roll-up shade element 25 is pulled out directly adjacent to the upper edge of the rear window 4, the incoming sunlight is very strongly reduced. The reduction is somewhat weaker next to this region, while no significant light screening is achieved in the lowest region directly adjacent to the rear seat shelf 15.

This division into different zones allows the part that is least important for the view to the back of the vehicle to be very strongly shaded in order to allow as little incoming sunlight here as possible. In the region of zone 51, which is still somewhat important for the view to the rear of the vehicle, the transparency represents a compromise between shading effect and visibility to the rear of the vehicle. The zone 52, which is located directly above the rear seat shelf 15 and which is most important for the view to the rear of the vehicle, has practically no reduction in transparency. The sunlight that can still enter here contributes to heating of the interior of the vehicle only to a small extent, and in particular, the comfort of passengers sitting in the rear is no longer negatively affected by the sun, although the sun can enter practically unimpaired through the zone 52.

Depending on the material that the roll-up shade element 25 is made from, different measures can be used in order to achieve the desired variance in the degree of transparency. For example, in FIG. 2, a cut out of a fabric 53 that can be used as the material of the roll-up shade element is shown schematically. This fabric can be changed in terms of the transparency, for example, by making the thread density in zone 50 greater than in zone 51 and, in turn, denser in zone 51 than in zone 52. Another way to vary the transparency using a fabric 52 arises, for example, from using warp threads in zone 50 which are colored nearly black, while the warp threads in zone 51 are merely colored gray, and in zone 52 there is absolutely no coloring. This configuration changes the light transmission in the region of the threads while the “mesh width” in the fabric remains unchanged. Combinations of these two methods also can be used. It is also possible to print the fabric 52 in order to obtain the varying transparency.

In FIG. 2, a cut out of a film 54 that can be used as a roll-up shade element 25 is shown. The film 54 that is made transparent by means of holes in an otherwise opaque film. In this case, for example, the film 54 can have no holes in the region of zone 50 and thus be completely opaque. The film can have relatively small holes in the region of zone 51, while large holes with a small hole spacing are used in the region of zone 52. If complete shading in the region of zone 50 is not desired, holes can also be provided here.

A cut out of a non-perforated but transparent film 55 that can be used as the material of the roll-up shade element 25 is shown in FIG. 2. The varying transparency of the film 55 can be achieved by printing the film with a pattern composed of black lines. The line pattern is selected so that the lines are very close to each other in the region of zone 50 with the lowest transparency, while the transparency in the region of zone 52 is at a maximum by providing absolutely no printing there. Any other suitable pattern can also be used. In particular with the use of a printing, the zones 50 to 52 can transition smoothly into each other, such that a “gray scale” is produced. This term is understood in the field of photography as the transition of the transparency or the density from completely black to white.

Finally, a cut out of a stitched material 56, for example, a knitted fabric that can be used as the material of the roll-up shade element 25 is shown in FIG. 2. The variance in the transparency can be established by selecting the mesh width in combination with the thread density. Coloring or printing is also possible for changing the transparency.

In the embodiment of FIG. 2, the individual zones of varying transparency lie parallel to the axis of the wind-up shaft 28, i.e., the zones exhibit a decreasing transparency with increasing height of the roll-up shade above the ground on which the vehicle is standing. Such variance in the transparency relative to the vertical direction is obviously also possible with the illustrated roll-up side window shade with the roll-up shade elements 21 and 22. Implementation of the invention with the shade elements 21 and 22 will be readily understood by one skilled in the art since the essentially rectangular roll-up shade element 21 can move in the same way as the roll-up shade element 25 of the roll-up rear window shade 23.

Another alternative for varying transparency is shown in FIG. 1. The transparency in the region of the roll-up shade element 22, which moves in the horizontal direction, is the lowest. The same transparency is achieved for the roll-up shade element 21 in the vicinity of the guide rail 17. In contrast, the transparency of the roll-up shade element 21 in the vicinity of the B column 3 is the best, i.e., here there is practically no light screening. In this embodiment, the transparency changes in the direction parallel to the longitudinal axis of the vehicle, while the transparency is isotropic in the vertical direction. The varying transparency of the roll-up shade elements 21 and 22 is indicated in FIG. 1 by a varying density of dots.

This type of varying transparency enables a passenger sitting in the rear of the vehicle to have a good outward view diagonally toward the front of the vehicle, while the passenger cannot be observed from outside from the side because the roll-up shade prevents looking in directly from the side. The drive for the roll-up shade element 22 is described in detail in DE 103 54 233.7 A1, the disclosure of which is explicitly incorporated herein by reference.

As the shown in the Figures of DE 103 54 233.78 A1, the wind-up shaft of the roll-up shade element 21 lies parallel to the window sill 20. That means that the roll-up shade has a transparency gradient that is aligned parallel to the wind-up shaft. That means that the transparency is greater next to one of the longitudinal edges of the roll-up shade element 22 than next to the other longitudinal edge.

Finally, the invention has been explained in connection with an electrically activated roll-up window shade. However, the invention is not limited to such drives. Instead, a hand actuated roll-up shade can be provided with varying transparency that varies in the direction parallel or perpendicular to the winding direction. Such a roll-up shade does not require the two guide rails 27. Instead, the extraction profile of the hanger 31 is provided with at least one hook and/or one handle in order to draw out the extraction profile and hang it at a suitable position next to the associated window edge. Such solutions are known to someone skilled in the art and therefore do not need to be explained here in detail since they are not the subject matter of the invention. Instead of a drive for the moving edge of the associated roll-up shade, it is also possible to couple the electric motor with the wind-up shaft and to use the spring 29, which is used as the spring motor, as a tension spring that pulls the extraction profile or the guide piece, for example, by means of cords, in the direction away from the wind-up shaft 28.

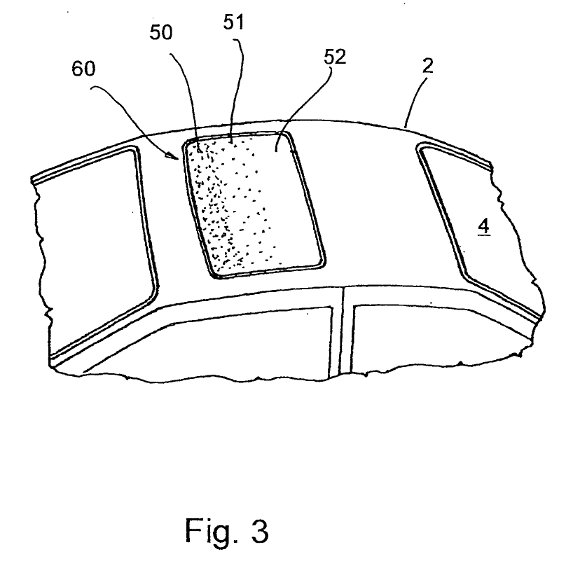

The invention has been explained above in connection with the side windows as well as the rear window of a motor vehicle. However, the present invention is not limited to these areas. The term windows in the motor vehicle can generally be understood to also be a glass roof or sliding sunroof 60 as shown in FIG. 3. In a known manner, a roll-up shade can be pulled out under the glass roof 60 in order to modulate the light coming in through the glass roof 60. A varying transparency can also be provided in the roll-up shade. As can be seen from FIG. 3, the already described regions 50, 51, and 52 of the roll-up shade are arranged one behind the other with varying transparency in the direction of travel. The lowest transparency is achieved at the front edge, while the greatest transparency is provided in the region of the rear edge of the glass roof 60. Therefore, it is possible to provide a lot of light in the rear region of the vehicle, while the driver is protected against direct sunlight from above.

A roll-up window shade for motor vehicles is provided. The transparency of the roll-up shade, when viewed over the surface area, is anisotropic. According to the desired and/or necessary transparency, the transparency changes from the top edge of the window to the bottom edge of the window such that in the region of the bottom edge of the window there is better transparency. In an alternative embodiment, the transparency changes from the rear edge of the window to the front edge of the window. The best transparency is provided next to the front edge of the window.

1. A roll-up window shade assembly for a motor vehicle window having a top edge and a bottom edge, the roll-up window shade assembly comprising:
a wind-up shaft that is supported so that it can rotate;
a roll-up shade element that is attached with an edge to the wind-up shaft, the roll-up shade element having a transparency that varies over the surface area of the roll-up shade element such that when the roll-up shade element is pulled in front of the motor vehicle window the transparency in the area of the top edge of the motor vehicle window is less than that in the area of the bottom edge of the motor vehicle window; and
a drive device for moving the wind-up shaft in a winding up direction of the roll-up shade element.

2. The roll-up window shade assembly according to claim 1, wherein the wind-up shaft extends parallel to the top edge of the motor vehicle window.

3. The roll-up window shade assembly according to one claim 1, wherein the wind-up shaft extends parallel to the bottom edge of the motor vehicle window.

4. The roll-up window shade assembly according to claim 1, wherein the wind-up shaft extends parallel to a rear edge of the motor vehicle window.

5. The roll-up window shade assembly according to claim 1, wherein the wind-up shaft extends parallel to a front edge of the motor vehicle window.

6. The roll-up window shade assembly according to claim 1, wherein the transparency changes abruptly from an edge of the roll-up shade element to another edge of the roll-up shade element.

7. The roll-up window shade assembly according to claim 1, wherein the transparency changes substantially continuously from an edge of the roll-up shade element to another edge of the roll-up shade element.

8. The roll-up window shade assembly according to claim 1, wherein the roll-up shade element comprises a stitched material having a mesh width that is changed according to the desired transparency.

9. The roll-up window shade assembly according to claim 1, wherein the roll-up shade element has a color that is varied according to the desired transparency.

10. The roll-up window shade assembly according to claim 1, wherein the roll-up shade element is knitted with varying density according to the desired transparency.

11. The roll-up window shade assembly according to claim 1, wherein the roll-up shade element has a varying thread density according to the desired transparency.

12. The roll-up window shade assembly according to claim 1, wherein the roll-up shade element comprises a film perforated with a plurality of holes in which the widths of the holes vary according to the desired transparency.

13. The roll-up window shade assembly according to claim 1, wherein the roll-up shade element comprises a perforated film that is printed with transparent patterns according to the desired transparency.

14. The roll-up window shade assembly according to claim 1, wherein the roll-up window shade element is a hand operated roll-up window shade and a hanging mechanism is provided at a free edge of the roll-up shade element remote from the wind-up shaft for fixing the roll-up shade element in the pulled out state.

15. The roll-up window shade assembly according to one of claim 1, wherein the roll-up window shade assembly is electrically activated such that an edge of the roll-up shade element remote from the wind-up shaft is connected to an extraction profile that is activated by means of push elements in a pulling out direction of the roll-up shade element.

16. The roll-up window shade assembly according to claim 15, wherein an electric motor is associated with at least one push element.

17. The roll-up window shade assembly according to claim 1, wherein an electric motor is associated with the wind-up shaft.

18. The roll-up window shade assembly according to claim 1, wherein the roll-up shade element has an outline that corresponds to the surface area of the motor vehicle window.

19. The roll-up window shade assembly according to claim 1, wherein the vehicle window comprises a side window, a rear window, or a sunroof.

20. A roll-up window shade assembly for a motor vehicle window having a front edge and a rear edge in the direction of a rear end of the vehicle, the roll-up window shade assembly comprising:
a wind-up shaft that is mounted so that it can rotate;
a roll-up shade element that is attached with an edge to the wind-up shaft, the roll-up shade element having a transparency that varies over the surface area of the roll-up shade element such that when the roll-up shade element is pulled in front of the motor vehicle window, the transparency in the area of the rear edge of the motor vehicle window is less than in the neighborhood of the front edge of the motor vehicle window; and with a drive device for moving the wind-up shaft in a winding up direction of the roll-up shade element.

21. The roll-up window shade assembly according to claim 20, wherein the wind-up shaft extends parallel to the top edge of the motor vehicle window.

22. The roll-up window shade assembly according to one claim 20, wherein the wind-up shaft extends parallel to the bottom edge of the motor vehicle window.

23. The roll-up window shade assembly according to claim 20, wherein the wind-up shaft extends parallel to a rear edge of the motor vehicle window.

24. The roll-up window shade assembly according to claim 20, wherein the wind-up shaft extends parallel to a front edge of the motor vehicle window.

25. The roll-up window shade assembly according to claim 20, wherein the transparency changes abruptly from an edge of the roll-up shade element to another edge of the roll-up shade element.

26. The roll-up window shade assembly according to claim 20, wherein the transparency changes substantially continuously from an edge of the roll-up shade element to another edge of the roll-up shade element.

27. The roll-up window shade assembly according to claim 20, wherein the roll-up shade element comprises a stitched material having a mesh width that is changed according to the desired transparency.

28. The roll-up window shade assembly according to claim 20, wherein the roll-up shade element has a color that is varied according to the desired transparency.

29. The roll-up window shade assembly according to claim 20, wherein the roll-up shade element is knitted with varying density according to the desired transparency.

30. The roll-up window shade assembly according to claim 20, wherein the roll-up shade element has a varying thread density according to the desired transparency.

31. The roll-up window shade assembly according to claim 20, wherein the roll-up shade element comprises a film perforated with a plurality of holes in which the widths of the holes vary according to the desired transparency.

32. The roll-up window shade assembly according to claim 20, wherein the roll-up shade element comprises a perforated film that is printed with transparent patterns according to the desired transparency.

33. The roll-up window shade assembly according to claim 20, wherein the roll-up window shade element is a hand operated roll-up window shade and a hanging mechanism is provided at a free edge of the roll-up shade element remote from the wind-up shaft for fixing the roll-up shade element in the pulled out state.

34. The roll-up window shade assembly according to one of claim 20, wherein the roll-up window shade assembly is electrically activated such that an edge of the roll-up shade element remote from the wind-up shaft is connected to an extraction profile that is activated by means of push elements in a pulling out direction of the roll-up shade element.

35. The roll-up window shade assembly according to claim 34, wherein an electric motor is associated with at least one push element.

36. The roll-up window shade assembly according to claim 20, wherein an electric motor is associated with the wind-up shaft.

37. The roll-up window shade assembly according to claim 20, wherein the roll-up shade element has an outline that corresponds to the surface area of the motor vehicle window.

38. The roll-up window shade assembly according to claim 20, wherein the vehicle window comprises a side window, a rear window, or a sunroof.

39. A roll-up window shade assembly for a for motor vehicle window having a front edge and a rear edge in the direction of the rear end of the motor vehicle, the roll-up window shade assembly comprising:
a wind-up shaft that is mounted so that it can rotate;
a roll-up shade element that is attached at an edge to the wind-up shaft, the roll-up shade element having a transparency that varies over the surface area of the roll-up shade element such that when the roll-up shade element is pulled in front of the motor vehicle window, the transparency in the area of the front edge of the motor vehicle window is less than in the area of the rear edge of the motor vehicle window; and
a drive device for moving the wind-up shaft in a winding up direction of the roll-up shade element.

40. The roll-up window shade assembly according to claim 39, wherein the wind-up shaft extends parallel to the top edge of the motor vehicle window.

41. The roll-up window shade assembly according to one claim 39, wherein the wind-up shaft extends parallel to the bottom edge of the motor vehicle window.

42. The roll-up window shade assembly according to claim 39, wherein the wind-up shaft extends parallel to a rear edge of the motor vehicle window.

43. The roll-up window shade assembly according to claim 39, wherein the wind-up shaft extends parallel to a front edge of the motor vehicle window.

44. The roll-up window shade assembly according to claim 39, wherein the transparency changes abruptly from an edge of the roll-up shade element to another edge of the roll-up shade element.

45. The roll-up window shade assembly according to claim 39, wherein the transparency changes substantially continuously from an edge of the roll-up shade element to another edge of the roll-up shade element.

46. The roll-up window shade assembly according to claim 39, wherein the roll-up shade element comprises a stitched material having a mesh width that is changed according to the desired transparency.

47. The roll-up window shade assembly according to claim 39, wherein the roll-up shade element has a color that is varied according to the desired transparency.

48. The roll-up window shade assembly according to claim 39, wherein the roll-up shade element is knitted with varying density according to the desired transparency.

49. The roll-up window shade assembly according to claim 39, wherein the roll-up shade element has a varying thread density according to the desired transparency.

50. The roll-up window shade assembly according to claim 39, wherein the roll-up shade element comprises a film perforated with a plurality of holes in which the widths of the holes vary according to the desired transparency.

51. The roll-up window shade assembly according to claim 39, wherein the roll-up shade element comprises a perforated film that is printed with transparent patterns according to the desired transparency.

52. The roll-up window shade assembly according to claim 39, wherein the roll-up window shade element is a hand operated roll-up window shade and a hanging mechanism is provided at a free edge of the roll-up shade element remote from the wind-up shaft for fixing the roll-up shade element in the pulled out state.

53. The roll-up window shade assembly according to one of claim 39, wherein the roll-up window shade assembly is electrically activated such that an edge of the roll-up shade element remote from the wind-up shaft is connected to an extraction profile that is activated by means of push elements in a pulling out direction of the roll-up shade element.

54. The roll-up window shade assembly according to claim 39, wherein an electric motor is associated with at least one push element.

55. The roll-up window shade assembly according to claim 39, wherein an electric motor is associated with the wind-up shaft.

56. The roll-up window shade assembly according to claim 39, wherein the roll-up shade element has an outline that corresponds to the surface area of the motor vehicle window.

57. The roll-up window shade assembly according to claim 39, wherein the vehicle window comprises a side window, a rear window, or a sunroof.
